(19) United States
(12) Patent Application Publication
(10) Pub. No.: US 2019/0265095 A1
(43) Pub. Date: Aug. 29, 2019

(54) CUSHION WITH SCALE

(71) Applicant: Yoon Hee JUN, Seoul (KR)

(72) Inventor: Yoon Hee JUN, Seoul (KR)

(21) Appl. No.: 16/107,337

(22) Filed: Aug. 21, 2018

(30) Foreign Application Priority Data
Feb. 26, 2018 (KR) 10-2018-0023092

(51) Int. Cl. G01G 19/52; G01G 5/00; G01G 19/44

(52) U.S. Cl. CPC G01G 19/52; G01G 23/36; G01G 19/44; G01G 5/006

(57) ABSTRACT

Provided is a cushion capable of accurately measuring and displaying a weight of a user sitting on the cushion, and convenient to store, use, and carry. The cushion includes a flexible sheet constituting a bottom part; a flexible seat having an integrated rectangular space part formed on the flexible sheet; a pressure transfer medium injected into the space part of the flexible seat; a pressure transfer medium injected into the space part of the flexible seat; and a scale for sensing pressure applied to the pressure transfer medium by an external pressure applied to the flexible seat and displaying the pressure as a weight, in which the scale includes a load cell, a base member, a control unit, a first display unit and a second display unit.

### BACKGROUND OF THE INVENTION

### 1. Field of the Invention

The present invention relates to a cushion, and more particularly, to a cushion with a scale, capable of measuring and displaying a weight of a user using the cushion and convenient to carry, store and use.

### 2. Description of the Related Art

In general, a cushion with a load measuring apparatus, in other words, a cushion with a scale is usually installed on a floor or the like of a chair in order to be used for posture correction, or installed therein with an additional device such as an acupressure device.

An example of a conventional cushion is disclosed in Korean Patent Registration No. 10-1551575.

As shown FIGS. 1 and 2, the conventional cushion 100 is provided with a body part 110 in the form of a cushion mat or a cushion in which external commercial power is received according to an on/off state of a power switch and supplied by converting the received power into necessary power. A plurality of air embossing units 120 injected therein with air are provided on an upper portion of the body part. A plurality of air injecting units 130-1 to 130-N supplied with the power from the body part 110 and injecting air into the air embossing units 120 according to an injection control signal.

In addition, a plurality of air pressure sensing units 140-1 to 140-N supplied with the power from the body part 110 to sense pressure of the air injected into the air embossing units 120.

A plurality of weight sensing units 160-1 to 160-N supplied with the power from the body part to sense partial weights of the user when the user using the cushion to correct a posture for a spine or the like sits on the air embossing units 120. A memory unit 180 is provided for presetting and storing an initial air pressure value for allowing the air embossing units to have the same height in an initial state before the user is seated, and correction air pressure values for correcting the posture to a normal symmetrical state in response to a body center while the user is seated.

In addition, a control unit 170 is provided in which the power is supplied from the body part 110, the body center of the user in a sitting state is determined by analyzing the partial weights sensed by the weight sensing units, the correction air pressure values corresponding to the determined body center of the user are read from the memory unit 180, and an air injection control signal, which allows the air to be injected into the air embossing units until the air pressure sensed by the air pressure sensing unit reaches the read correction air pressures, is generated and inputted into the air injection units.

In addition, a plurality of air discharge units 150-1 to 150-N supplied with the power from the body part 110 to discharge the air injected into the air embossing units according to a discharge control signal inputted from the control unit.

The control unit 170 is configured to generate a discharge control signal that allows the air injected into the air embossing units to be discharged until the air pressure sensed by the air pressure sensing unit reaches the read correction air pressures, and configured to input the discharge control signal to the air discharge units.

The cushion configured as described above is driven through the steps of: receiving external commercial power according to an on/off state of the power switch to convert the received power into necessary power and supply the necessary power, by the body part 110;

receiving power from the body part to sense pressure of the air injected into the air embossing units 120 provided on the upper portion of the body part, by the air pressure sensing units 140-1 to 140-N;

receiving the power from the body part to sense partial weights of the user, by the weight sensing units 160-1 to 160-N, when the user for posture correction sits on the air embossing units;

determining, by the control unit 170, the body center of the user while the user is seated by analyzing the partial weights sensed by the weight sensing units;

receiving the power from the body part to read correction air pressure values corresponding to the determined body center of the user, by the control unit;

generating an air injection control signal, which allows the air to be injected into the air embossing units 120 until the sensed air pressure reaches the read correction air pressure values, to input the air injection control signal to the air injection units 130-1 to 130-N, by the control unit; and

receiving, by the air injection unit, the power from the body part to inject the air into the air embossing units 120 according to the air injection control signal.

Although the conventional cushion 100 configured and controlled as described above is specialized for correcting a body unbalance of the user, there is a limit for using the conventional cushion as a general cushion, it is inconvenient to carry and store, and there is a structural problem that an accurate weight cannot be measured when the user sits on the cushion because the cushion has a feature that a cushion part is required to be installed.

Documents of related art: Korean Patent Registration No. 10-1551575.

### SUMMARY OF THE INVENTION

To solve the above problems of the conventional arts, the present invention provides a cushion capable of accurately measuring and displaying a weight of a user sitting on the cushion, and convenient to store, use, and carry.

In addition, the present invention provides a cushion in which, when the cushion user input a predetermined weight value and then sits on the cushion, the inputted weight value is compared with a measured weight value on a user, and the difference value is displayed or alarmed, so that an increase/decrease of the weight of the user is easily recognized.

To this end, the cushion with a scale of the present invention includes: a flexible sheet constituting a bottom part, a flexible seat having an integrated rectangular space part formed on the flexible sheet, a pressure transfer medium injected into the space part of the flexible seat, and a scale for sensing pressure applied to the pressure transfer medium by an external pressure applied to the flexible seat and displaying the pressure as a weight, wherein

the scale includes a load cell positioned in the space part of the flexible seat to sense the pressure applied to the pressure transfer medium without coming into contact with the flexible seat, a control unit for calculating the pressure applied to the load cell as the weight, and a display unit for displaying the calculation result of the control unit as a weight value.

In addition, the scale may further include a base member fixed to the flexible sheet constituting the bottom part to support the load cell.

In addition, the display unit may include a first display unit for displaying a weight value that is actually measured, and a second display unit for displaying a difference between a predetermined set value inputted through the control unit and the weight value of the first display unit.

In addition, the pressure transfer medium may include air or fluid.

In addition, a thickness of the space part of the flexible seat may be in a range of 30 mm to 100 mm, and an area of an upper surface of the flexible seat may be in a range of 900 cm² to 2,500 cm².

According to the cushion with a scale of the present invention, a load cell is provided in the space part of an integrated flexible seat having one space part, the load cell provided in the space part senses pressure applied to the space part, and the load cell is positioned at a lower portion of the flexible seat and supported by the base member fixed to the flexible sheet constituting the bottom part, so that the accuracy for measuring a load can be ensured even if the scale is provided in the cushion having a cushion part.

In addition, the cushion is soft so as to be easily rolled, folded or bent for storage even if the scale is installed in the cushion, so that the scale can easily serve as a usual cushion in a home, a restaurant, or the like.

### BRIEF DESCRIPTION OF THE DRAWINGS

FIG. 1 is a perspective view showing a conventional cushion for posture correction.

FIG. 2 is a block diagram showing a conventional cushion for posture correction.

FIG. 3 is a perspective view showing a cushion with a scale of the present invention.

FIG. 4 is a sectional view showing a cushion with a scale of the present invention.

FIG. 5 is a sectional view showing a state in which a load is applied to a cushion with a scale of the present invention.

FIG. 6 is a block diagram showing a cushion with a scale of the present invention.

FIG. 7 is a sectional view showing another example of a cushion with a scale of the present invention.

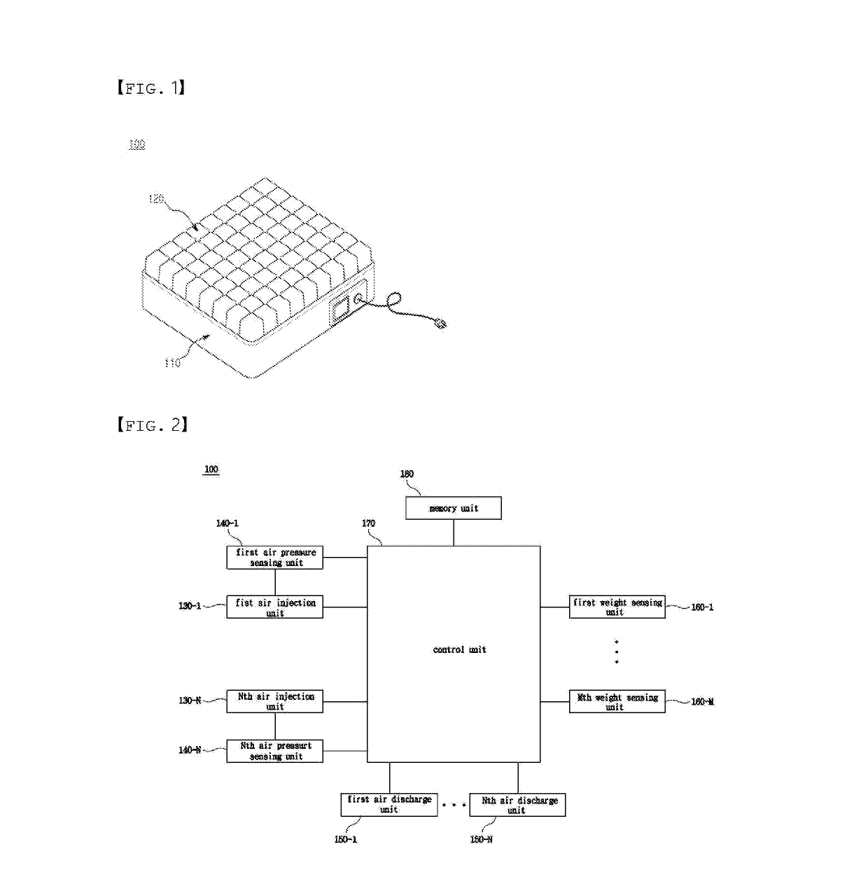

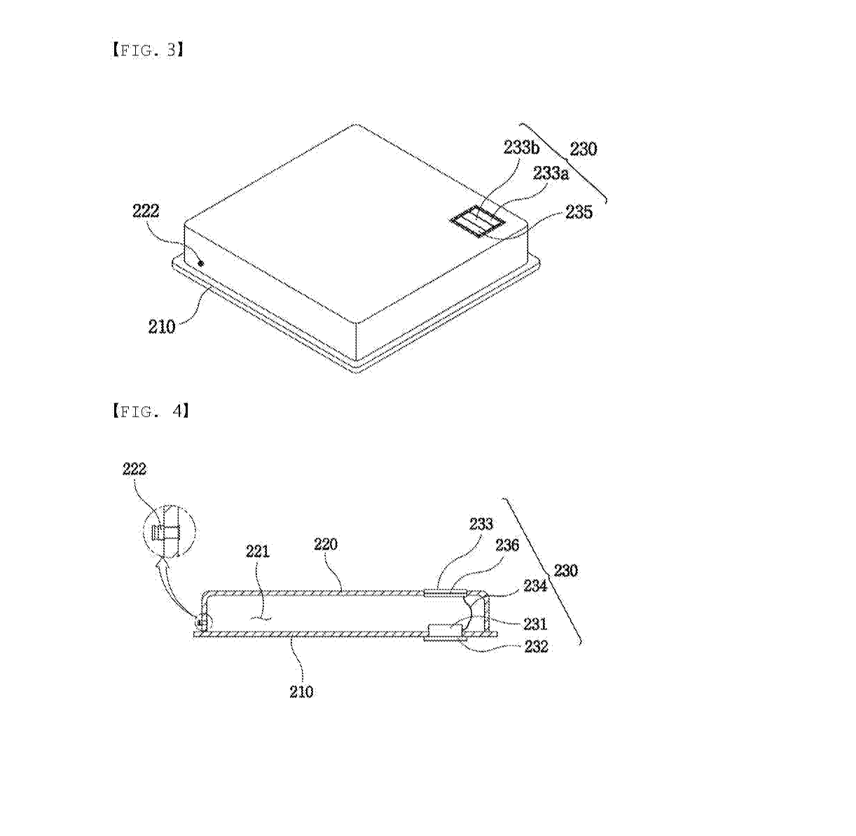

### DETAILED DESCRIPTION OF THE INVENTION

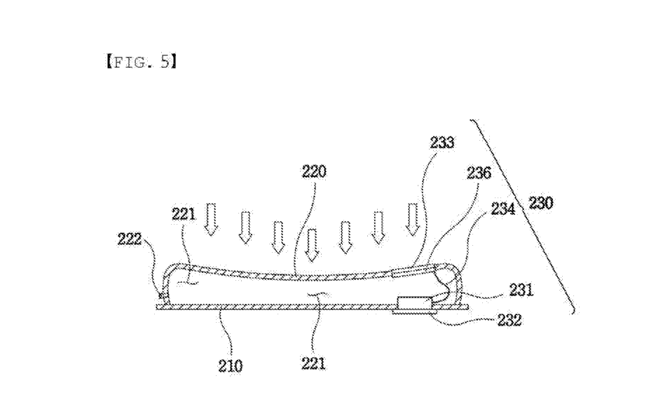

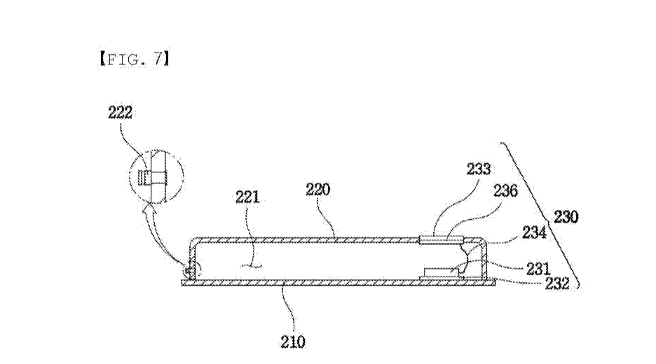

Hereinafter, the technical configuration and operation of the cushion with a scale of the present invention will be described in detail with reference to FIGS. 3 to 7.

As shown in FIGS. 3, 4 and 6, the cushion 200 with a scale of the present invention includes a flexible sheet 210 constituting a bottom part, and a flexible seat 220 having an integrated rectangular space part 221 formed on the flexible sheet.

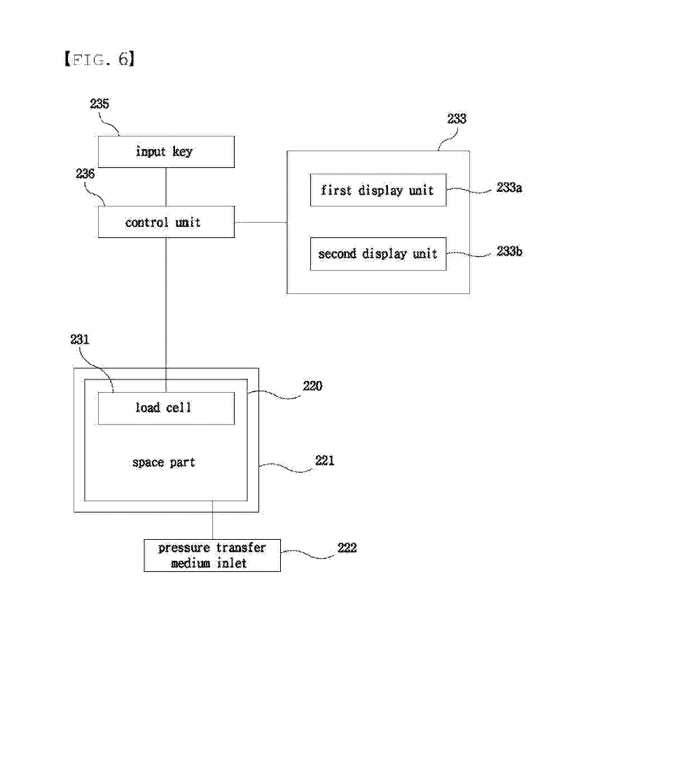

The flexible sheet 210 may be formed of a fabric, or a natural or artificial leather to which vinyl or the like for maintaining the airtightness is attached. In addition, the flexible seat 220 may be formed of a material such as a leather which is flexible and has low elasticity to prevent a pressure transfer medium from leaking to the outside, even if pressure is applied to the pressure transfer medium injected into the space part in a state that the integrated space part 221 is completely sealed in an airtight state at a portion on which a user using the cushion seats (Preferably, the pressure transfer medium is formed of air for weighting and handling convenience though any fluid such as air and water may be used). As shown in FIG. 5, when the user sits on the flexible seat 220 while putting the weight of the user thereon, the pressure transfer medium is required to be injected enough to prevent a surface of the flexible seat 220 from coming into contact with a surface of the flexible sheet 210. This is because an accurate load cannot be measured if the surface of the flexible seat 220 comes into contact with the surface of the flexible sheet 210 when the user seats, while putting the weight, on the flexible seat 220, due to small amounts of the pressure transfer medium which is injected.

The pressure transfer medium may be injected or exhausted at suitable amounts through a pressure transfer medium inlet 222.

Particularly, a scale 230, which senses pressure applied to the pressure transfer medium by an external pressure applied to the flexible seat and displays the pressure as a weight, is installed in the cushion.

As shown in FIG. 4 for example, the scale 230 includes a load cell 231 positioned in the space part 221 of the flexible seat to sense the pressure applied to the pressure transfer medium without coming into contact with the flexible seat, a base member 232 formed of a hard material such as plastic, exposed and fixed to an outer side of the flexible sheet 210 constituting the bottom part so as to support the load cell, a control unit 236 for calculating the pressure applied to the load cell into the weight, and a display unit 233 for displaying the calculation result of the control unit as a weight value. The control unit 236 and the load cell 231 are connected to each other by a wiring 234, and the control unit 236 may be supplied with power by using a small battery (not shown).

The load cell 231 is not limited to a structure, as shown FIG. 4, in which the load cell 231 is fixed to the base member 232 formed of a hard material such as plastic exposed and fixed to the outer side of the flexible sheet 210. The load cell 231, as shown in FIG. 7, may be fixed to the flexible sheet 210 in the space part, such that the base member 232 is prevented from being exposed to the outer side of the flexible sheet 210.

The load cell 231 is configured by using a principle in which a physical strain generated in a detecting unit of an elastic strain member, which generates a structurally stable deformation with respect to a force or a load, is converted into an electrical resistance variance by using a strain gauge, and the electrical resistance variance is converted into a precise electrical signal by an electrical circuit referred to as a wheat stone bridge. Since the above technique has been already known and used for a scale or the like, a detailed description will be omitted.

In addition, the display unit 233 includes a first display unit 233a for calculating pressure applied to the load cell by the control unit 236 and displaying the calculated pressure as a weight value, and a second display unit 233b for displaying a difference between a predetermined set value inputted by the user through the control unit and the weight value of the first display unit. The second display unit may be configured by adding a separate alarm device or voice device. The first display unit 233a, the second display unit 233b, and the alarm device are configured as described above to provide information for preventing the cushion user from overeating foods more than a predetermined weight when the cushion user eats the foods.

In addition, an input key 235 may be additionally configured to set a mode as a weight measurement mode, reset contents displayed on the display unit 233, or command an instruction to the control unit. For example, the setting a mode as a weight measurement mode signifies that the control unit preliminarily deduction-calculates a pressure value of the pressure transfer medium injected into the space part 221 in a state that the user is not sitting on the cushion, such that a display window displays “0 Kg”. Of course, when the user sits on the cushion seat set as the weight measurement mode, the deduction-calculated pressure value is added to the additional pressure value applied onto the cushion seat, such that the weight value of the user may be accurately displayed on the first display unit.

Although the present invention illustrated the structure that the control unit 236 and the display unit 233 are provided on the flexible seat, the control unit 236 and the display unit 233 also may be arranged outside the cushion and connected by a wiring cable or the like.

In addition, the base member 232 supporting the load cell 231 is fixed to the flexible sheet 210 of the bottom part to minimize an influence of the cushion parts of the cushion on the pressure sensing of the load cell.

When the user places the weight of the user on the cushion of the present invention configured in the above manner, especially on the flexible seat 220, a thickness of the space part of the flexible seat 220 may be about 30 mm to about 100 mm to prevent a surface of the flexible seat 220 from coming into contact with a surface of the flexible sheet 210, and an area of an upper surface of the flexible seat may be 900 cm² to 2500 cm² to enable the user to sit thereon with an entire body weight.

What is claimed is:

1. A cushion with a scale, the cushion comprising:
a flexible sheet constituting a bottom part;
a flexible seat having an integral rectangular space part formed on the flexible sheet;
a pressure transfer medium injected into the space part of the flexible seat; and
a scale for sensing a pressure applied to the pressure transfer medium by an external pressure applied to the flexible seat and displaying the pressure as a weight, wherein
the scale includes
a load cell positioned in the space part of the flexible seat to sense the pressure applied to the pressure transfer medium without coming into contact with the flexible seat,
a control unit for calculating the pressure applied to the load cell into the weight, and
a display unit for displaying the calculation result of the control unit as a weight value.

2. The cushion of claim 1, wherein the scale further includes a base member fixed to the flexible sheet constituting the bottom part to support the load cell.

3. The cushion of claim 1, wherein the display unit includes a first display unit for displaying a weight value which is actually measured, and a second display unit for displaying a difference between a predetermined set value inputted through the control unit and the weight value of the first display unit.

4. The cushion of claim 1, wherein the pressure transfer medium includes air or fluid.

5. The cushion of claim 1, wherein a thickness of the space part of the flexible seat is in a range of 30 mm to 100 mm, and an area of an upper surface of the flexible seat is in a range of 900 cm² to 2,500 cm².
